(19) United States
(12) Patent Application Publication
(10) Pub. No.: US 2009/0085868 A1
(43) Pub. Date: Apr. 2, 2009

(54) Composite notebook

(75) Inventor: Yi-An Lai, Kuei Shan Hsiang (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/076,218

(22) Filed: Mar. 14, 2008

(30) Foreign Application Priority Data
Sep. 29, 2007 (TW) 96216343

(51) Int. Cl. G09G 5/00; G06F 3/041; G06F 3/033

(52) U.S. Cl. 345/157; 345/169; 345/173

(57) ABSTRACT

The present invention is a composite notebook, comprising a notebook main body, a controller, and wireless communication units thereon, wherein the controller comprises a switch unit, a touch screen, a keypad unit, a signal processing unit, and a power supply module. The controller respectively provides a joint operation mode when being attached to the notebook main body and a separate operation mode when being detached from the notebook main body.

### RELATED APPLICATIONS

This application claims priority to Taiwan Application Serial Number 96216343, filed Sep. 29, 2007, which is herein incorporated by reference.

### BACKGROUND

1. Field of Invention

The present invention relates to a composite notebook. More particularly, the present invention relates to a composite notebook with a detachable controller inserted thereon.

2. Description of Related Art

The side demonstration function, SideShow, of the new-type of operating system, such as Vista, enables the sub-screen or second display outside the notebook to display photos, e-mails, and play media when the system of the notebook is in Hibernation mode or in Power-off mode. Using the side demonstration function of a notebook may not only save the electric power to extend the power source supply time, but also exempt users from keeping on switching the notebook on and off to check e-mails or playing media. And with the increased popularity of wireless networks, video phone conversations using a notebook can be carried out over the network.

Therefore, to meet various functions such as the side demonstration function of the new-type of operating system and the wireless video phone, a detachable controller of a composite notebook is applied for nowadays notebooks.

### SUMMARY

The invention provides a composite notebook, comprising a notebook main body, a controller, and two wireless communication units respectively disposed both thereon. The controller, which can be attached to and detached from the notebook main body, is detachably disposed in the socket trough of the notebook main body. The controller respectively provides a joint operation mode when being attached to the notebook main body and a separate operation mode when being detached from the notebook main body. The data communication and various function signals are transmitted through the wireless communication units, such as Bluetooth, wireless USB or other like.

When the controller is attached to the notebook main body, the controller is switched into the joint operation mode and provides functions such as pointing device function and SideShow function. Due to the controller has a touch screen, the controller can make the touch screen as a sub-screen or a second display and provide control function to the notebook through the touch screen when the controller is attached to the notebook main body. In the SideShow function, a user is able to read information through the sub-screen, such as photos, e-mails, system information, multi-media playing programs, when the notebook is in Hibernation mode or in Power-off mode.

In addition, when the controller is detached from the notebook main body, the controller is switched into a separate operation mode and acts as a portable electronic device for playing multi-media, a VoIP (Voice over Internet Protocol) phone or a digital frame for playing images. As a portable electronic device for playing multi-media files stored in the notebook through wireless communication units, the controller further comprises an audio output or an audio output terminal. As a VoIP phone to communicate with other people through wireless communication units, the controller further comprises an audio output, a microphone and a camera.

By this invention, the controller is able to play various multimedia files stored in the hard disk of the notebook by communicating with the notebook main body through wireless communication units as a portable television, a MP3 player, and a MP4 player. Or, the controller can provide mobile phone functions like a network phone, a video phone, etc.

### BRIEF DESCRIPTION OF THE DRAWINGS

The invention can be more fully understood by reading the following detailed description of the embodiment, with reference made to the accompanying drawings as follows:

FIGS. 1A and 1B illustrate schematic diagrams of the preferred embodiment of a composite notebook of this invention.

FIG. 2 is the block diagram of the preferred embodiment of a composite notebook of this invention.

FIG. 3 illustrates the controller of the preferred embodiment of a composite notebook of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

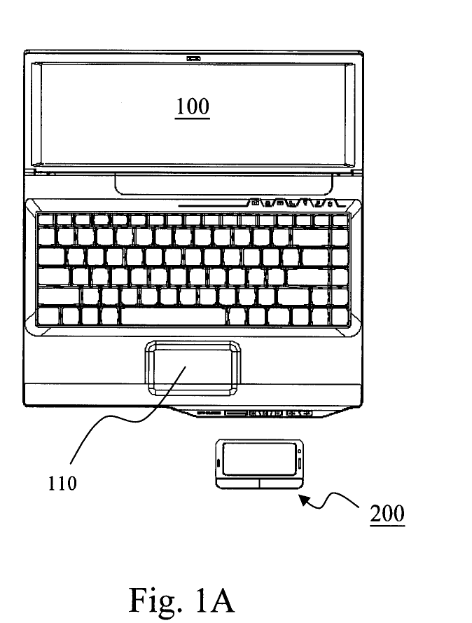

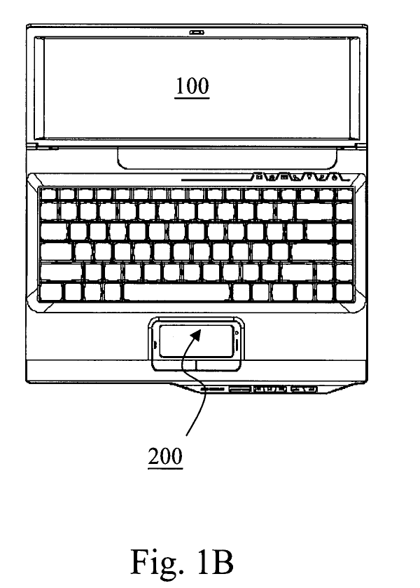

Refer to FIG. 1A and FIG. 1B. FIG. 1A and FIG. 1B illustrate schematic diagrams of the preferred embodiment of a composite notebook of this invention. As shown in FIG. 1A and FIG. 1B, the invention includes a notebook main body 100 and a controller 200, which is alternatively attached to or removed from the notebook main body 100. The notebook main body 100 has a socket trough 110 for detachably placing the controller 200 within. The controller 200 can be inserted into the socket trough 110 on the notebook main body 100 to enter a joint operation mode, or removed from the notebook main body 100 to enter a separate operation mode.

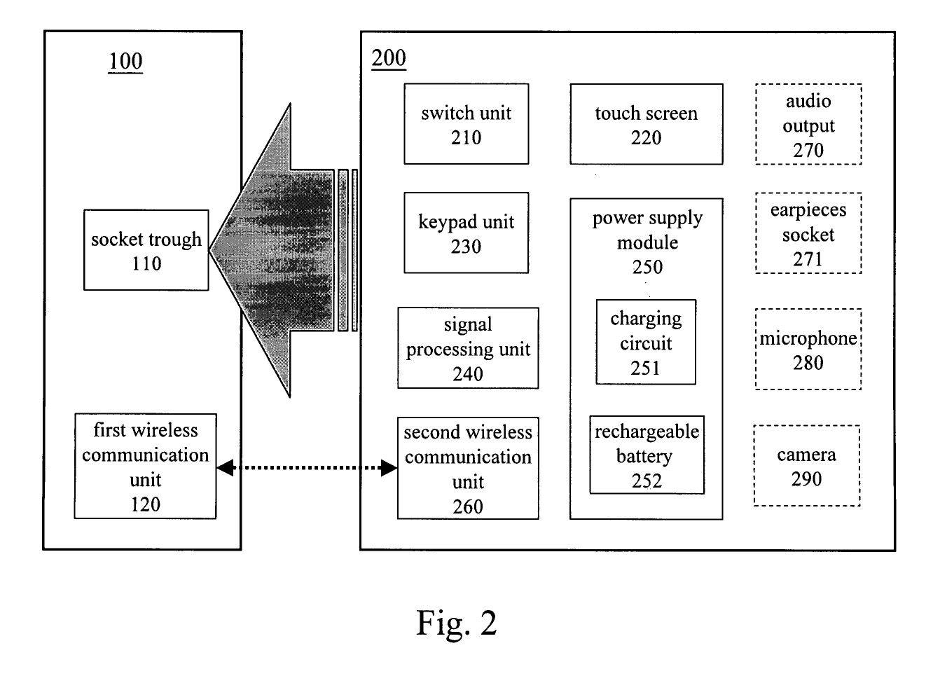

Refer to FIG. 2. FIG. 2 is the block diagram of the preferred embodiment of a composite notebook of this invention. The composite notebook of this invention comprises a notebook main body 100 and a controller 200. The notebook main body 100 has a first wireless communication unit 120, and a socket trough 110 for placing the controller 200 within. The controller 200 comprises a switch unit 210, a touch screen 220, a keypad unit 230, a signal processing unit 240, a power supply module 250, and a second wireless communication unit 260. The switch unit 210 switches the controller 200 either the joint operation mode or the separate operation mode, in other words, the controller 200 is switched automatically to the joint operation mode when attached to the notebook main body 100 and switched automatically to the separate operation mode when removed from the notebook main body 100. The touch screen 220 is a screen with a touch sensing function, using resistive touch sensing technique and capacitive touch sensing technique, etc. for displaying images and information; and providing a user with touch control functions. The keypad unit 230 provides alternatively keyboard functions corresponding to the joint operation mode and the separate operation mode. The signal processing unit 240 processes data signals from the controller 200 and send the processed data signals to the notebook main body 100, and processes data signals received from the notebook main body 100, through the first wireless communication unit 120 and second wireless communication unit 260. The power supply module 250 comprises a charging circuit 251 and a rechargeable battery 252, and provides operation power to the controller 200. The power supply module 250 connects a power circuit of the notebook main body 100 for recharging when the controller 200 is inserted into the socket trough 110 attaching to the notebook main body 100. The communication between the notebook main body 100 and the controller 200 is through the first wireless communication unit 120 and the second wireless communication unit 260 with a wireless communication protocol, e.g. the Bluetooth protocol, wireless USB protocol or other like.

The switching between the separate operation mode and the joint operation mode by the switch unit 210 can be implemented with mechanical actuator, e.g. a switch shaft (not shown in this figure), disposed on the controller 200. That is, while inserting the controller 200 into the socket trough 110 to attach to the notebook main body 100, the switch shaft is mechanically shoved and thus switch the controller 200 to the joint operation mode; and while pulling out the controller 200 from the socket trough 110 to remove from the notebook main body 100, the switch shaft is mechanically rebounded and thus switch the controller 200 to the separate operation mode. Or, the switching can be implemented with electronic actuator, e.g. connection or disconnection of the charging circuit 251. That is, while inserting the controller 200 into the socket trough 110 to attach to the notebook main body 100, the charging circuit 251 connects to the power circuit of the notebook main body 100; and once the connection happened, the controller 200 is switched to the joint operation mode; and while pulling out the controller 200 from the socket trough 110 to remove the controller 200 from the notebook main body 100, the charging circuit 251 disconnects from the power circuit of the notebook main body 100 and the controller 200 is switched to the separate operation mode at the same time.

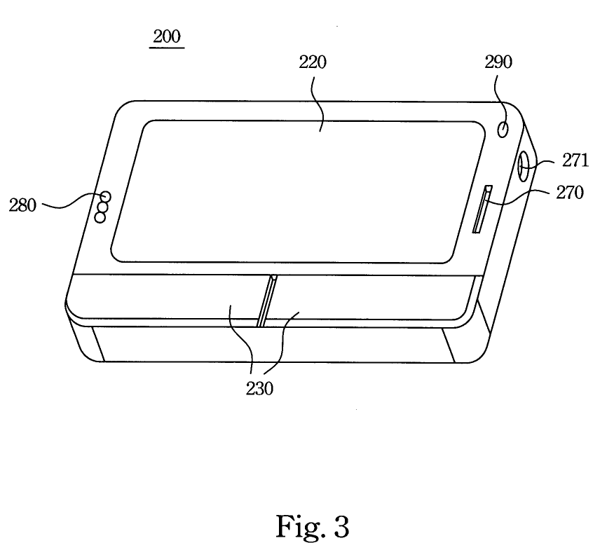

Refer to FIG. 3. FIG. 3 illustrates the controller of the preferred embodiment of a composite notebook of this invention. The controller 200 can be attached to and detached from the notebook main body 100, and alternatively provide the joint operation mode interface for attaching to the notebook main body 100 and the separate operation mode interface for detaching from the notebook main body 100. Therefore, when the controller 200 is attached to the notebook main body 100 (i.e. entering joint operation mode), the controller 200 acts as a pointing device through the touch screen 220 (for example, touchpad) and the keypad unit 230 acts as mouse keys such as left and right buttons. Moreover, when the notebook main body 100 is in Hibernation mode or Power-off mode in the joint operation mode, the touch screen 220 of the controller 200 can provide SideShow function, such as displaying e-mails, voice messages, system information and playing multi-media, etc. And the touch screen 220 can further provide controls function for displaying and playing. Similarly, when the controller 200 is detached from the notebook main body 100 (entering the separate operation mode), it acts as a portable electrical device, a multi-media player or a VoIP (Voice over Internet Protocol) phone. In one embodiment, the controller 200 further comprises an audio output 270 and an audio output terminal such as an earpieces socket 271, when the controller 200 acts as a multi-media player and communicates with the notebook main body 100 through the first wireless communication unit 120 and the second wireless communication unit 260 to play the multi-media files stored in the notebook and to display various information or e-mail. In one embodiment, the controller 200 further comprises an audio output 270, a microphone 280 and a camera 290 when the controller 200 acts as a VoIP (Voice over Internet Protocol) phone and communicates with the notebook main body 100 through the first wireless communication unit 120 and the second wireless communication unit 260 with instant messaging software (IM software) such as Skype, Google Talk and so on.

In this present invention, the controller and the notebook communicate with each other wirelessly to achieve real time communications. When the controller is attached to the notebook main body, the controller is switched to the joint operation mode automatically; and the touch screen and the buttons act as a touchpad and mouse key respectively. Moreover, once the controller is attached to the notebook main body, the rechargeable battery begins to be recharged. In addiction, the controller can provide SideShow function to display e-mails, voice messages, system information and play multi-media gaming when the notebook is in Hibernation mode or Power-off. On the other hand, when the controller is detached from the notebook main body, the controller is switched to the separate operation mode to display instantaneous messages such as e-mails, voice messages, multimedia programs, various information and battery capacities. Also, the touch screen of the controller can provides simple controls to the notebook through the wireless protocol.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A composite notebook, comprising:
a notebook main body, having a socket trough and a first wireless communication unit; and
a controller, detachably inserted in the socket trough and alternatively attached to or removed from the notebook main body, providing a joint operation mode and a separate operation mode, wherein the controller comprises:
a switch unit, for switching the controller into either the joint operation mode or the separate operation mode;
a touch screen, for sensing a touch control and displaying;
a keypad unit, for providing alternative keyboard functions corresponding to the joint operation mode and the separate operation mode;
a signal processing unit, for processing data signals from and to the notebook main body;
a power supply module, comprising a charging circuit and a rechargeable battery; and
a second wireless communication unit
wherein the first wireless communication unit and the second wireless communication unit communicates with each other through a wireless communication protocol.

2. The composite notebook of claim 1, wherein the power supply module connects a power circuit of the notebook main body for recharging when the controller is inserted into the socket trough attaching to the notebook main body.

3. The composite notebook of claim 2, wherein the switch unit switches the controller to the joint operation mode according to connecting or disconnecting between the charging circuit and the power circuit of the notebook main body.

4. The composite notebook of claim 1, wherein the wireless communication protocol is Bluetooth protocol.

5. The composite notebook of claim 1, wherein the controller acts as a pointing device of the notebook in the joint operation mode.

6. The composite notebook of claim 5, wherein the pointing device is a touchpad.

7. The composite notebook of claim 1, wherein the controller provides a SideShow function in the joint operation mode when the notebook is in a Hibernation mode or a Power-off mode.

8. The composite notebook of claim 7, wherein the SideShow function provides functions selected from: displaying e-mails, displaying voice messages, displaying system information and playing multimedia.

9. The composite notebook of claim 1, wherein the controller acts as a portable electronic device in the separate operation mode.

10. The composite notebook of claim 9, wherein the controller further comprises an audio output or an audio output terminal.

11. The composite notebook of claim 1, wherein the controller acts as a VoIP (Voice over Internet Protocol) phone in the separate operation mode.

12. The composite notebook of claim 11, wherein the controller further comprises an audio output and a microphone.

13. The composite notebook of claim 11, wherein the controller further comprises a camera.

14. The composite notebook of claim 1, wherein the controller acts as a digital frame in the separate operation mode.
